(19) United States
(12) Patent Application Publication
(10) Pub. No.: US 2020/0205155 A1
(43) Pub. Date: Jun. 25, 2020

(54) DOWNLOADING AND STORING VIDEO CONTENT OFFLINE TO MANAGE VIDEO PLAYBACK

(71) Applicant: ARRIS Enterprises LLC, Suwanee, GA (US)

(72) Inventor: Sundar Murthy Tumuluru, Bangalore (IN)

(21) Appl. No.: 16/227,809

(22) Filed: Dec. 20, 2018

(51) Int. Cl. H04W 72/04; H04W 24/08; H04L 12/26

(52) U.S. Cl. CPC H04W 72/0453; H04W 88/02; H04L 43/0882; H04W 24/08

(57) ABSTRACT

A wireless device may send a request to one or more wireless networks to download content associated therewith (e.g., currently playing, on a play list for future consumption). Request may be sent when wireless device is remote from one or more wireless networks or when wireless device is connected to wireless network and available bandwidth is limited. Request may include information about content, current playback position of content, and location of wireless device. Wireless network may receive request and determine an estimated arrival time for wireless device and an estimated playback location for currently-playing content. Wireless network may download content from content provider off line and store content in storage device connected to wireless network. Wireless device may access stored content when connected to wireless network and play content from storage or copy content thereto.

### BACKGROUND

More and more content is available via the Internet. The content may be live content or may be prerecorded content. The content may be viewed on any device having an Internet connection and a display. The devices may range from stationary devices such as Internet enabled televisions or entertainment systems to portable devices such as cellular phones, tablet computers, lap top computers and portable media players. Many of the portable devices may be capable of connecting to the Internet either via a mobile network or via a local area network providing wireless communications, often referred to as a wireless network or a WiFi network. The WiFi network is connected to a broadband network and the broadband network connects to the Internet.

FIG. 1 illustrates an example system diagram 100 showing how wireless devices 160 may receive content via the Internet 120 from a content provider (or content providers) 110. The content provider(s) 110 may be, for example, a network (e.g., NBC, CNN, ESPN, HBO) providing broadcast programming content (e.g., either pre-recorded or live streaming) or a repository of content that can be selected for on-demand viewing (e.g., Netflix, Hulu, or any of the networks). The content provider(s) 110 may be connected to the Internet 120. The wireless devices 160 may connect to the Internet 120 and access content from the content providers 110 via a mobile network 130, such as a cellular network provided by any of the cellular carriers. The wireless devices 160 may also connect to the Internet 120 and access content from the content providers 110 via a broadband delivery network (wide area network) 140. The delivery network 140 may be, for example, a cable network, a telephony network, or a satellite network. The wireless devices 160 may connect to the delivery network 140 via a wireless local area network 150, such as a WiFi network, that is connected to the delivery network 140. In order to connect to the WiFi network 150 the wireless devices 160 need to be in close proximity to an access point for the WiFi network 150. The access point may be, for example, a wireless router. Other devices (e.g., Internet enabled devices) 170 may also connect to the access point for the WiFi network 150 via wired connections.

Regardless of the manner in which the wireless devices 160 connect to the content providers 110, for pre-recorded content the content may be downloaded to the wireless device 160 and stored thereon. The content may be then be played from storage so as to not have to stream in real time. However, all of the content need not be downloaded prior to playback. Rather after some initial content has been downloaded the content can be played while additional content is downloaded. The quality of the playback may vary based on the bandwidth that is available for, and the signal strength of, the network (e.g., mobile 130, wireless 150). If adaptive streaming is operational, the download bit rate may vary depending on the network bandwidth and signal strength and the quality and/or resolution of the content may vary according (e.g., low bandwidth and/or low signal strength equals low bit rate and accordingly low quality and/or low resolution).

When a WiFi network 150 is available, it is desirable to connect to the WiFi network 150 as the use of a WiFi network 150 and delivery network 140 is more cost effective than the mobile network 130. However, when a user is on the go and is not located within a known location the ability to connect to a WiFi network 150 may not be available and the only choice may be to connect via the mobile network 130. Accordingly, when a user is away from a WiFi network 150 and they want to view content the content is provided over the mobile network 130. When the user returns to where they can connect to the WiFi network 150, the wireless device may connect to the WiFi network 150 and the content may be provided therefrom.

However, the content download and playback on the WiFi network 150 depends on a number of factors including, but not limited to, available bandwidth, congestion on the network (e.g., how many devices are connected thereto), frequency bands supported (e.g., 2.4 GHz, 5 GHz). If the WiFi network 150 has available bandwidth and is not congested then when a wireless device 160 returns home and connects thereto, the playback quality may increase from that provided by the mobile network 130. However, if the WiFi network 150 is congested (many devices connected thereto) then the playback quality may actually decrease when the wireless device 160 connects to the WiFi network 150. In some situations, it is possible that the WiFi network 150 is so congested that the download and playback of content at that time may not be possible.

### SUMMARY

A method for utilizing a local area network to manage video playback on a wireless device associated with the local area network. The method includes receiving a message from the wireless device that includes information about content associated with the wireless device and a request for the local area network to download the content. The content is downloaded from a content provider offline via the local area network. The content is stored on a storage device connected to the local area network. A determination is made as to when the wireless device is connected to the local area network. The wireless device is provided access to the stored content.

A device to provide a wireless device an access point to a local area network and to manage video playback on the wireless device. The device includes a wireless interface to communicate with one or more wireless devices. A processor is communicatively coupled to a memory for storing network configuration information including network topology. A computer-readable storage medium to store instructions that when executed by the processor cause the processor to receive a message from the wireless device that includes information about content associated with the wireless device and a request for the local area network to download the content. The content is downloaded from a content provider offline via the local area network and stored on a storage device connected to the local area network. A determination is made as to when the wireless device is connected to the local area network. The wireless device is provided access to the stored content.

A system to manage video playback on a wireless device associated with a local area network. The system includes a mobile agent and a router agent. The mobile agent is to prepare a message including information about content associated with the wireless device, location of the wireless device and a request to download the content and send the message to the local area network. The router agent is to receive the message from the wireless device, download the content from a content provider offline, store the content on a storage device connected to the local area network, determine when the wireless device is connected to the local area network and provide the wireless device access to the stored content.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates an example system diagram showing how wireless devices may receive content via the Internet from content providers.

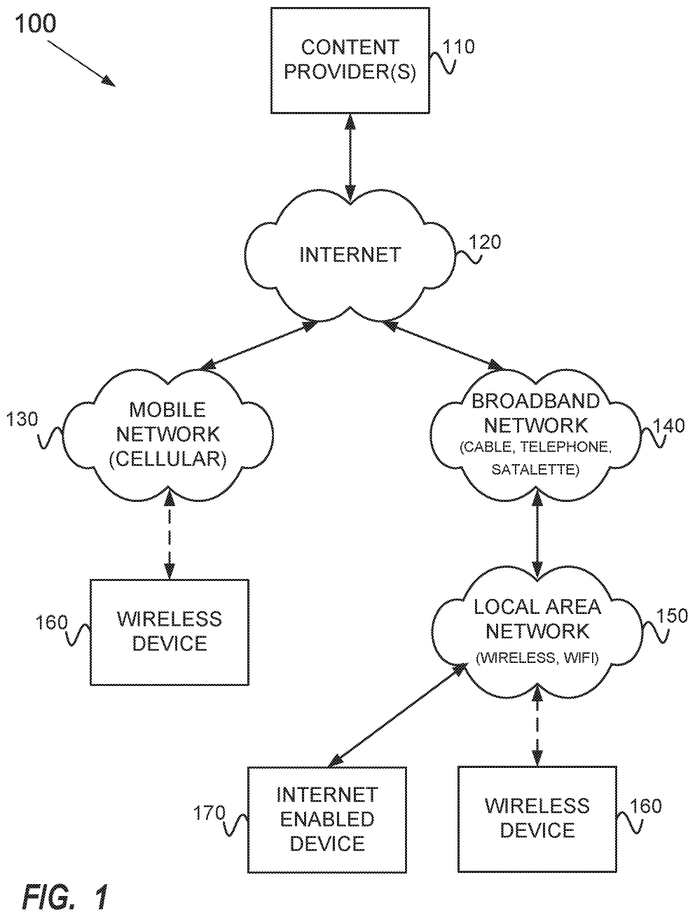

FIG. 2 illustrates an example high level functional diagram of a wireless device that can be utilized to retrieve and play content, according to one embodiment.

FIG. 3 illustrates an example high level functional diagram of an access point, such as a gateway/router for a WiFi network, according to one embodiment.

FIG. 4 illustrates an example process flow for a mobile agent operating on a wireless device, according to one embodiment.

FIG. 5 illustrates an example process flow for a router agent operating on an access point (e.g., router), according to one embodiment.

FIG. 6 illustrates an example process flow of a wireless device transitioning from actively downloading content to using content previously downloaded offline and stored on a local area network for content currently playing thereon, according to one embodiment.

FIG. 7 illustrates an example process flow of a wireless device transitioning from actively downloading content to using content previously downloaded offline and stored on a local area network for content included in a wish list, according to one embodiment.

FIG. 8 illustrates an example process flow of a wireless device connected to a local area network transitioning from playing actively downloading content to offline downloading and storing of the content and playing the stored content, according to one embodiment.

FIG. 9 illustrates an example process flow of a local area network downloading and storing content offline and a wireless device copying the content thereto for later playback thereon, according to one embodiment.

### DETAILED DESCRIPTION

Providing communication and coordination between a wireless device and a wireless local area network (WiFi) network that the wireless device may connect to can ensure that content playback can occur on the WiFi network. Furthermore, the communications and coordination may ensure that the quality of the playback of content does not decrease when the wireless device connects to the WiFi network from a mobile network. The communications and coordination may include the wireless device sharing with an access point for the WiFi network the content that it is playing and/or is scheduled to be played on the wireless device. The WiFi network may utilize the information to download at least portions of the appropriate content in advance to avoid issues associated with congestion of the WiFi network.

In order for this communication to occur between the wireless device and the WiFi network (access point), the wireless device may include a mobile agent and the access point may include a router agent. The functions of the mobile agent and the router agent and the communications therebetween will be discussed in more detail below.

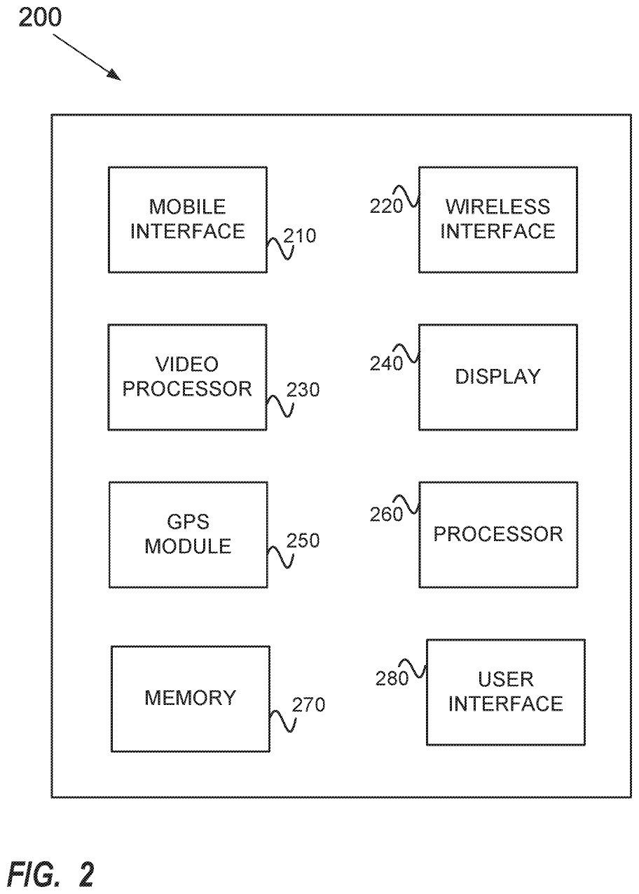

FIG. 2 illustrates an example high level functional diagram of a wireless device 200 that can be utilized to retrieve and play content. The wireless device 200 may include a mobile interface 210, a wireless interface 220, a video processor 230, a display 240, a GPS module 250, a processor 260, memory 270, and a user interface (UI) 280. The mobile interface 210 may be to provide communications via a mobile network (e.g., cellular) 130, including connecting to the Internet. The mobile interface 210 may include a radio for transmitting and receiving data and associated protocols for enabling communications. The wireless interface 220 may be to provide communications directly with other wireless devices or with a wireless network 150 that may provide connectivity to the other wireless devices or with a broadband delivery network 140 for connecting to the Internet. The wireless interface 220 may be, for example, WiFi (wireless local area networking based on the IEEE 802.11), Bluetooth (IEEE 802.15.1) or NFC (near field communications). The wireless interface 220 may include a radio for transmitting and receiving data and associated protocols for enabling communications.

The video processor 230 may be to prepare audio video content for presentation on the wireless device 200. The video processor 230 may have to decompress the video content prior to presentation. The display 240 may be to present the content to the user, including the playback of video content. The GPS module 250 is to determine the location of the wireless device 200. The processor 260 is to control the operation of the mobile device 200 and execute processor executable instructions (e.g., software, apps). For example, the processor 260 may execute instructions that cause it to act as a mobile agent as will be discussed in more detail below. The memory 270 is to store the processor executable instructions and/or other data. The other data may include content that is to be displayed on the wireless device 200. The memory 270 may be located on the processor 260 and/or may be separate from the processor 260. The memory 270 storing the processor executable instructions may be processor readable memory so that the processor 260 can read and execute the processor executable instructions. The UI 280 may be to provide information to the subscriber and enable the subscriber to interact with the device 200. As one skilled in the art would recognize, the types of UIs 270 may vary greatly based on the device 200.

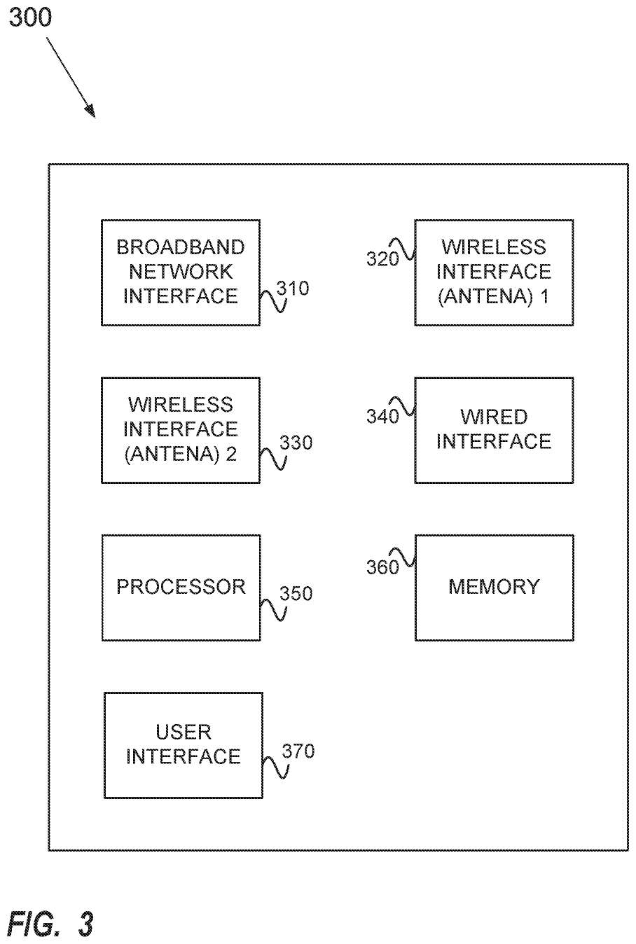

FIG. 3 illustrates an example high level functional diagram of an access point, such as a gateway/router 300 for a local area network (LAN) providing wireless (WiFi) communications. Such a network may be referred to as a LAN, wireless network, or WiFi network. The gateway/router 300 may include a broadband network interface 310, a first WiFi interface (antenna) 320, a second WiFi interface (antenna) 330, a wired interface 340, a processor 350, memory 360 and a user interface 370. Network extenders may have similar functional diagrams, but likely do not include the broadband network interface 310. In addition, some network extenders may not include multiple WiFi interfaces but rather may be limited to operating at a single WiFi frequency.

The broadband network interface 310 is to provide connectivity to and communications with a broadband network 140. The network interface 310 may include a connector, for example, a coaxial connector for receiving a coaxial cable and associated protocols for providing the necessary communications with the broadband network 140 (e.g., receiving data from and transmitting data to). The broadband network 140 provides access to external content and external systems including the Internet.

The first and second WiFi interfaces (antennas) 320, 330 are to provide WiFi communications between the gateway/router 300 and wireless devices (establish WiFi networks). The first WiFi interface 320 may be to establish a WiFi network operating at a first frequency (e.g., 5 GHz network pursuant to IEEE 802.11a) and the second WiFi interface 330 may be to establish a WiFi network operating at a second frequency (e.g., 2.4 GHz network pursuant to IEEE 802.11b,g). According to one embodiment, it is possible that a single chip includes multiple antennas and can provide communications at different frequencies (e.g., 2.4 and 5 GHz network pursuant to IEEE 802.11n). The wireless devices may utilize the gateway/router 300 to communicate with other wireless devices within the location or may use it as an access point to connect to the broadband network 140.

The wired interface 340 is to provide wired communications between the gateway/router 300 and other devices that can communicate via a wired interface. The other devices may use the gateway/router 300 to communicate with wireless devices (or wired devices) within the location. The other devices may use the gateway/router 300 to access, for example the Internet, via the broadband network 140. The other devices may be capable of wireless communications even if they connect via the wired interface 340. The other devices may be network extenders that extend the range of the wireless network within the location. The other devices may be various computing devices and/or Internet enable devices, including but not limited to a set top box (STB), an entertainment system, storage device and appliance. The wired interface 340 may include a connector (e.g., coaxial, Ethernet, USB) to receive an appropriate cable and associated protocols for receiving and transmitting data thereover.

The processor 350 is to control the operation of the gateway/router 300. The processor 350 is to execute computer-executable instructions (e.g., software, apps). The computer executable instructions, when executed, may cause the processor 350 to control the operations of the gateway/router 300 and perform various functions including, but not limited to, network configuration, activity monitoring and analysis (e.g., statistics, analytics), and adjusting the network configuration, device connectivity, and/or device operations as required. Some of the functions performed by the processor 350 are based on data that is collected about the network and the devices connected thereto. In addition, the processor 350 may execute instructions that cause it to act as a router agent as will be discussed in more detail below.

The memory 360 is to store the computer-executable instructions and/or other data. The other data may include, for example, configuration data (e.g., set-up of the wireless network), connectivity data (e.g., wireless devices actively connected to the wireless network, signal strength of connected devices, congestion of access points) and/or activity data (e.g., when a wireless device connects to an access point and whether it was a new connection or a transfer from another access point, when a device losses connectivity to an access point). The gateway/router 300 may receive data related to what is connected to the network extenders from the network extenders. The data may be received from the network extenders, for example, when wireless devices connect or disconnect from the network extenders, when the wireless devices communicate with the broadband network 140 which requires communications with the gateway/router 300 and/or at defined intervals (e.g., every few seconds).

The memory 360 may be located on the processor 350 and/or may be separate from the processor 350. The memory 360 storing the computer-executable instructions may be computer-readable memory so that the processor 350 can read and execute the computer-executable instructions.

The memory 360 may be supplement with external memory that may be located in other access points, in a set top box (STB) or any other device having storage that is connected to the wireless network (via a wireless or wired connection) and/or is in the cloud and can be accessed via a broadband network.

The user interface 370 may include, for example, lights to provide a user an indication about the operational status thereof. The user interface 370 may also include, for example, switches, buttons or the like to enable the user to, for example, power on/off and/or reset the gateway/router 300.

The mobile agent within a wireless device is to communicate with the router agent within an access point (e.g., router) for one or more wireless (WiFi) local area networks that the wireless device often connects to. The mobile agent is to communicate information about content that the wireless device is playing or desires to play with the one or more WiFi networks. The mobile agent may also utilize location data about wireless device and the one or more WiFi networks in order to determine when the wireless device will be available to connect to the one or more WiFi networks. It may also utilize the location information to determine if content that is currently playing will be complete when the wireless device connects to the one or more WiFi networks at which time the wireless device may switch to receiving the content from the WiFi network.

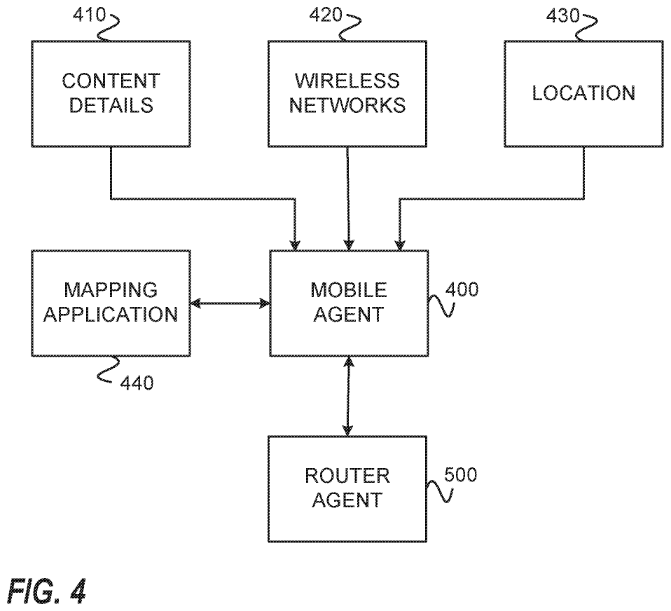

FIG. 4 illustrates an example process flow for a mobile agent 400 operating on a wireless device. The mobile agent 400 may receive information regarding content 410 that the wireless device is currently playing or has scheduled to be played, information related to wireless (WiFi) networks 420 that the wireless device has previously connected to, and information related to location 430 of the wireless device. The content information 410 may be at least some portion of the meta data related to the content including, but not limited to, title of the content, location where the content is being downloaded from (e.g., content server), audio-video format of the content, media container format, and duration of the content. The content information 410 may also include other information, such as current playback position for content currently being played and order of proposed content playback for content included in a wish list.

The WiFi network information 420 may include an indication of whether the wireless device is currently connected to a WiFi network and a list of WiFi networks that the wireless device has connected to (e.g., home network, work network, gym network, restaurant network). The WiFi network information 420 may also include connection details for these WiFi networks, including but not limited to, location of the WiFi network, day and time the WiFi connection was established and day and time the WiFi connection was terminated. The WiFi network information 420 may include statistics and/or analytics that were calculated for these WiFi networks including, but not limited to, details regarding when the wireless device typically connects to these WiFi networks (e.g., every evening around 6 pm, Mon-Fri around 9 am, weekends around 7 am), how often the wireless device connects to these WiFi networks (e.g., twice a day, once a week), how long the wireless device stays connected to these WiFi networks (e.g., 10 hours, 6 hours, 30 minutes), how long the wireless device is typically connected to a mobile network before it connects to these WiFi network (e.g., 20 minutes, 1 hour), whether the wireless device typically comes from another WiFi network prior to connecting to these WiFi networks (e.g., from work WiFi) and whether the wireless device typically goes to another WiFi network after disconnecting from a WiFi network (e.g., to home WiFi).

The wireless device location information 430 may include information about the location of the wireless device, whether the wireless device is moving and what direction the wireless device is headed. The wireless device location information 430 may be captured by the GPS module 250.

The mobile agent 400 may become active when the wireless device is playing content (or is scheduled to play content). Once activated, the mobile agent 400 may receive the content information 410, the WiFi network information 420 and the wireless device location information 430 and may begin processing the information received. Initially, the mobile agent 400 may make a determination about where the wireless device may be headed (e.g., is it headed to a specific WiFi network, are any WiFi networks excluded). It should be noted that the determination of which WiFi network the wireless device may or may not be headed to may be limited to those networks that the mobile agent 400 will have permission to communicate with and utilize the resources of (e.g., personal networks, home networks). That is, the mobile agent 400 may not be authorized to communicate with or use resources of a WiFi network that the wireless device connects to at, for example, a restaurant, a store or a gym.

The initial determination may be made based on historical data that has been collected about the wireless device. For example, at the end of a work day the wireless device may typically travel home and connect to the home WiFi network. On weekends, the wireless device may typically head to a cabin and connect to the cabin WiFi network. The initial determination may be augmented or replaced by comparing the movement of the wireless device captured in the wireless device location information 430 to locations of the WiFi networks captured in the WiFi network information 420. For example, if the device is traveling in a north bound direction and one or more of the WiFi networks are south from a current location of the device those WiFi networks may be excluded. The mobile agent 400 may interact with a mapping program (e.g., Google Maps®) 440 in order to compare the location and movement of the wireless device to the location of the WiFi networks. The interaction with the mapping program 440 may be via the Internet 120.

Once a set of possible WiFi networks is identified, the mobile agent 400 may determine an estimated time of arrival at each of the possible WiFi networks. The mobile agent 400 may interact with the mapping program 440 in order to determine the expected arrival time at each of the WiFi networks. The mobile agent 400 may compare the estimated travel time to the remaining content duration for currently-playing content to determine if the content will still be playing when the wireless device arrives at the WiFi network.

The mobile agent 400 may send messages to each of the possible WiFi networks. The messages may act as a request to download content and may include an actual request. The messages may be sent to router agents 500 for the possible WiFi networks. The messages may include, but is not limited to, information about any content being played (e.g., title, duration, current playback position, audio-video format, media container format), any content included in a wish list for the wireless device (e.g., title, duration, audio-video format, media container format), and location of the wireless device. The messages may be sent via the Internet 120. As the WiFi network (access point) is connected to the Internet 120 via the delivery network 140, the messages may be routed through the delivery network 140.

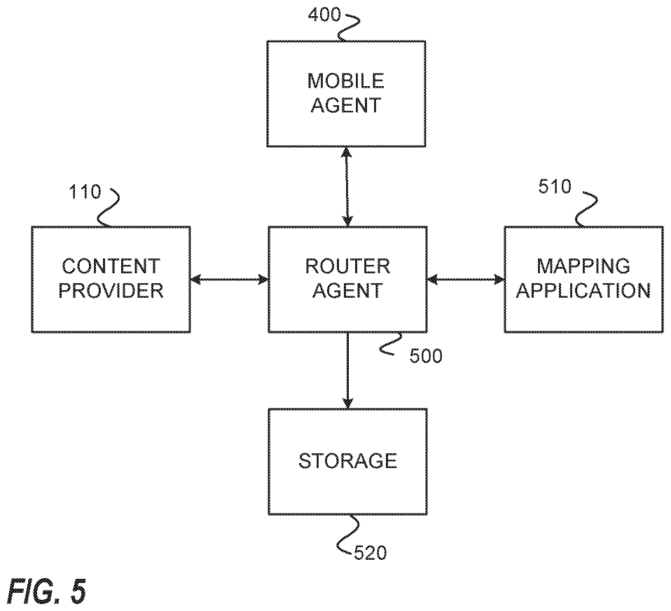

FIG. 5 illustrates an example process flow for the router agent 500 operating on an access point (e.g., router). The router agent 500 may receive the messages from the mobile agent 400. As noted above, the messages may act as a request to download content and may include an actual request. The router agent 500 may utilize the information regarding the location of the wireless device from the messages and the location information about where it is located and determine an estimated time of arrival for the wireless device. The router agent 500 may interact with a mapping application 510 in order to determine the estimated arrival time. The mapping application 510 may be the same as the mapping application 440 or may be a different application.

For content currently being played on the wireless device, the router agent 500 may determine an estimated playback point at the time that the wireless device arrives at the location (e.g., will be 44 minutes into the 60 minute movie, will have 16 minutes of the movie remaining).

The router agent 500 may communicate with the content providers 110 to download content. The content may be downloaded offline (e.g., not while the user is consuming it). The content may be downloaded by the access point (e.g., router) or the router agent may instruct other devices to download the content. The content may be downloaded via available wireless bandwidth or wired bandwidth. The downloaded content may be stored in storage 520 connected to the WiFi network. The storage 520 may be for example, a hard drive of a STB, available storage within any device connected to the WiFi network (e.g., entertainment system, computer) or a storage device connected to the WiFi network. The download of the content may be the entire content or at least a portion thereof so that the wireless device can play that portion from the storage 520 while additional content continues to be downloaded offline.

The router agent 500 may communicate the location of the storage 520 where the content is being stored to the mobile agent 400 when the wireless device connects to the WiFi network and the timing for switching to the stored content from the downloading of the content to provide a seamless transition. The switching to downloaded content when the user connects to the WiFi network should ensure that the quality of the content playback is maintained or increased as any bandwidth limitations with the WiFi network should not affect quality. Furthermore, as the wireless device need not connect to the Internet 120 via the WiFi network in order to obtain the content at that point, the impact to bandwidth of the wireless device joining the WiFi network is reduced.

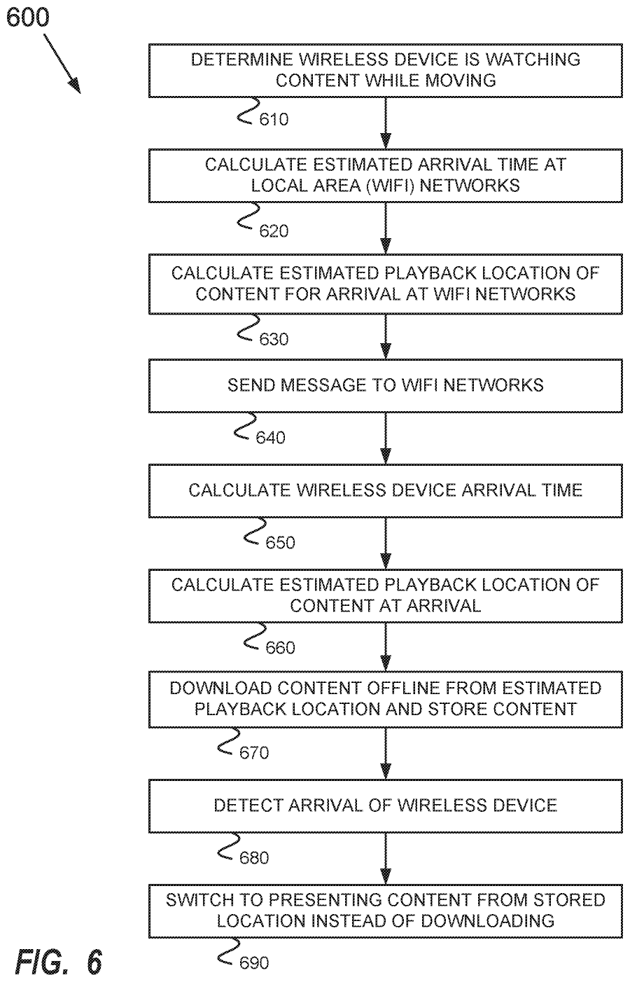

FIG. 6 illustrates an example process flow of a wireless device transitioning from actively downloading content to using content previously downloaded offline and stored on a local area network (WiFi) for content currently playing thereon 600. Initially the wireless device is determined to be watching content while the wireless device is traveling and is connected to the mobile network 610. The mobile agent calculates travel time to arrive at one or more possible local area (WiFi) networks that the wireless device may be headed to 620. The mobile agent calculates an estimated playback location of the content at the WiFi networks based on the current playback location and the estimated arrival times at the WiFi networks 630. For the WiFi networks where it is estimated that the content will still be playing when the wireless device arrives, the mobile agent may send messages to the WiFi network (router agent) 640. As described above, the messages may include information about the content, the current playback location in the content and the current location of the wireless device.

When the routing agent receives the message, the routing agent may calculate an estimated arrival of the wireless device 650 and an estimated playback location of the content at the arrival time 660. The routing agent may then instruct the router or other device connected to the WiFi network (either via wireless connection or wired connection) to connect with the content providers 110 to download the content from the estimated playback location 670. The content may be downloaded at an appropriate bit rate offline. The content may be stored in a storage device connected to the WiFi network. The routing agent may detect when the wireless device connects to the WiFi network 680. It should be noted that if the message from the mobile agent was sent to more than one router agent, that a subset of the router agents may not detect the arrival of the wireless device. Once the wireless device has been detected by the WiFi network, the mobile agent and the router agent may communicate to have the content being presented switch from an active download to the stored content 690.

The method 600 is in no way intended to be limited to the illustrated processes. Rather, additional processes can be added, processes can be combined, processes can be deleted, processes can be modified and/or the order of the processes can be modified without departing from the current scope.

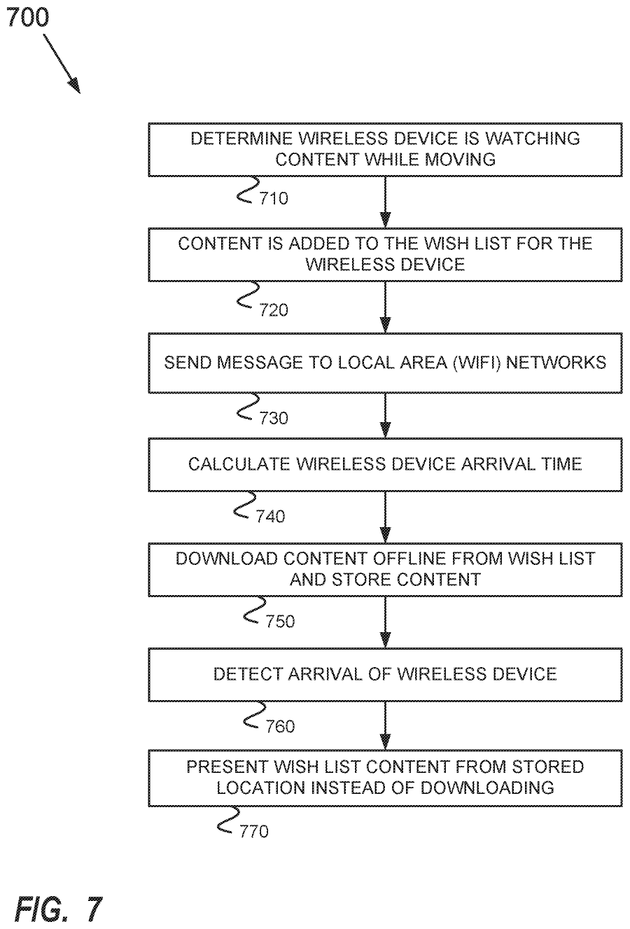

FIG. 7 illustrates an example process flow of a wireless device transitioning from actively downloading content to using content previously downloaded offline and stored on a local area network (WiFi) for content on a wish list 700. Initially the wireless device is determined to be watching content while the wireless device is traveling and is connected to the mobile network 710. The user adds content to a wish list for the wireless device 720. The wireless device may be configured to continue to play content including content on the wish list in sequential order. The mobile agent may send messages to router agents associated with one or more possible local area (WiFi) networks that the wireless device may be headed to 730. As described above, the messages may include information about the content in the wish list and the current location of the wireless device.

When the routing agent receives the message, the routing agent may calculate an estimated arrival of the wireless device 740. The routing agent may then instruct the router or other device connected to the WiFi network (either via wireless connection or wired connection) to connect with the content providers 110 to download the content from the wish list 750. The content may be downloaded at an appropriate bit rate offline. The content from the wish list is then stored in a storage device connected to the WiFi network. The routing agent may detect when the wireless device connects to the WiFi network 760. It should be noted that if the message from the mobile agent was sent to more than one router agent, that a subset of the router agents may not detect the arrival of the wireless device. Once the wireless device has been detected by the WiFi network, the mobile agent and the router agent may communicate so that when the content from the wish list is to be played that the content is taken from the stored content (and need not download) 770.

The method 700 is in no way intended to be limited to the illustrated processes. Rather, additional processes can be added, processes can be combined, processes can be deleted, processes can be modified and/or the order of the processes can be modified without departing from the current scope.

FIGS. 6 and 7 focus on downloading content to a WiFi network before the wireless device connects to the WiFi network in order to prevent playback issues that may be associated with the WiFi network being congested (not having sufficient bandwidth available to download the content in real time) and affecting the quality of the content being presented as the connectivity switches from the mobile network 120 to the WiFi network. The issues associated with content playback when a wireless device enters the WiFi network may also exist when the wireless device is connected to the WiFi network. That is, congestion may affect the quality of content that is presented on a wireless device when the wireless device is connected to the WiFi network and actively downloading the content it is presenting.

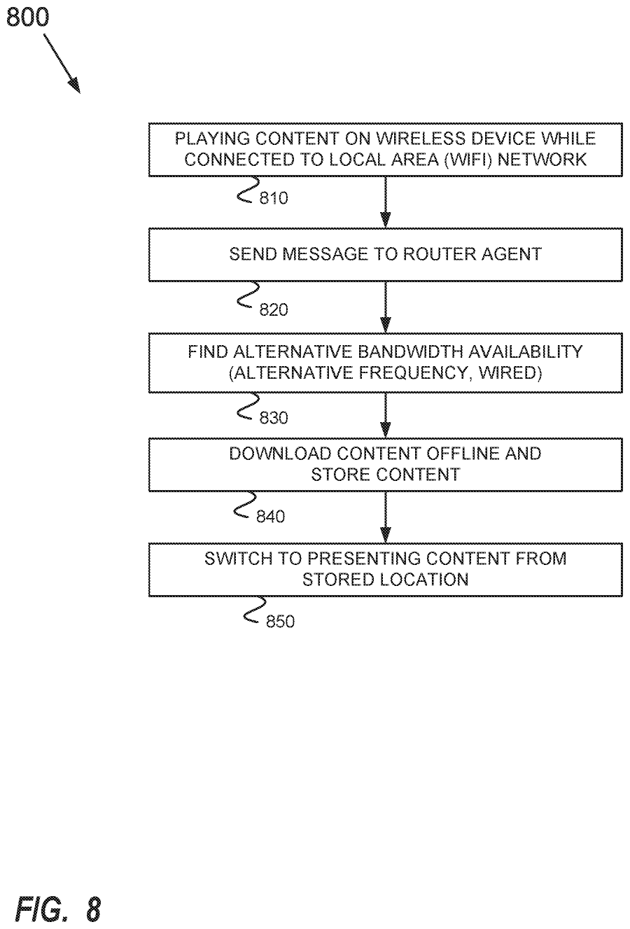

FIG. 8 illustrates an example process flow of a wireless device connected to a local area (WiFi) network transitioning from playing actively downloading content to downloading and storing of the content offline and playing the stored content 800. Initially the wireless device is playing content while connected to a WiFi network 810. The content is being downloaded and played in real time and there may be some quality issues associated therewith. For example, a particular WiFi frequency band that the wireless device supports (e.g., 2.4 GHz, 5 GHz) may be congested. The mobile agent may send a message to the router agent regarding the content that is being played 820. The message may include a request for downloading the currently-playing content via some other means (e.g., different wireless frequency band, wired connection). The router agent may find available bandwidth via alternative means, such as on alternative frequency bands (e.g., 5 GHz, 2.4 GHz) or wired connection 830. The router agent may then instruct the router or devices connected to the WiFi network (e.g., a wireless device, a wired device) to download the content offline and store it in a storage device connected to the WiFi network 840. The portion of the content that is downloaded and stored may be configurable (e.g., entire content, from current playback position, from a certain time after the current playback position). Once the content is downloaded, the router agent may switch the presentation of the content from active download to the stored content 850.

The method 800 is in no way intended to be limited to the illustrated processes. Rather, additional processes can be added, processes can be combined, processes can be deleted, processes can be modified and/or the order of the processes can be modified without departing from the current scope.

FIGS. 6-8 have focused on downloading content to a WiFi network so that when the content is played on the wireless device when the wireless device is connected to the WiFi network the content can be played from storage rather that actively downloading the content for presentation. Sometimes content may be downloaded for storage on the wireless device so that the content can be played at a later time, possibly when there is no Internet connectivity via the mobile network 120 or a WiFi network. The downloading of the content to the wireless device via the mobile network 120 or a WiFi network may result in bit rate problems based on the signal strength and bandwidth available.

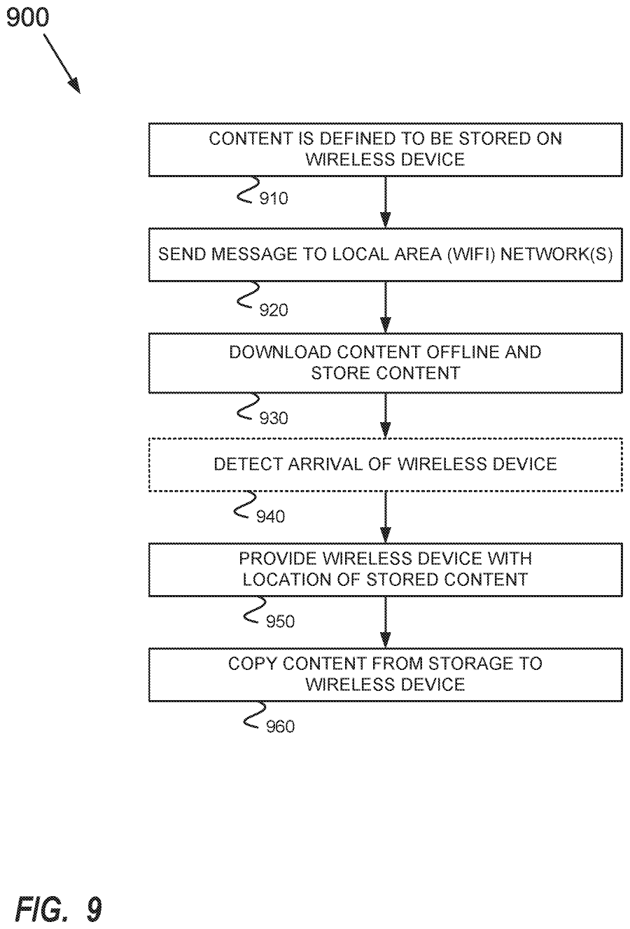

FIG. 9 illustrates an example process flow of a local area (WiFi) network downloading and storing content offline and a wireless device copying the content thereto for later playback thereon 900. Initially the wireless device defines content that it would like to store thereon for later playback 910. The content may be added at any point (e.g., while connected to mobile network, while connected to WiFi network). The mobile agent may send messages to one or more possible WiFi networks (router agents) that the wireless device may connect to 920. As described above the messages may include information about the content and the current location of the wireless device. It should be noted that if the content is added while the wireless device is connected to a WiFi network the message may simply be sent to that router agent and the location of the wireless device may not be included in the message.

When the routing agent receives the message, the routing agent may instruct the router or other devices connected to the WiFi network, to connect with the content providers 110 to download and store the content in a storage device connected to the WiFi network 930. The content may be downloaded at an appropriate bit rate offline. If the wireless device was not connected to the WiFi network at the time the message was sent, the routing agent may detect when the wireless device connects to the WiFi network 940. After the content has been downloaded and the wireless device is connected to the WiFi network, the router agent may provide the wireless device with a location where the content is stored 950. The wireless device may then copy the content from the location where it is stored 960. Once the content has been copied to the wireless device the wireless device may view the content regardless of being connected to the Internet.

The method 900 is in no way intended to be limited to the illustrated processes. Rather, additional processes can be added, processes can be combined, processes can be deleted, processes can be modified and/or the order of the processes can be modified without departing from the current scope.

Computer-executable instructions (e.g., software, apps) may be stored on a computer-readable storage medium (e.g., 270, 360). The computer-executable instructions when executed by a processor (e.g., 260, 350) may cause the processor to perform any of the methods 600-900.

The various embodiment described above have been described with respect to the wireless device connecting to a local area (WiFi) network that they control (e.g., personal network, home network). The disclosure is in no way intended to be limited thereto. For example, a hotel may include access to a WiFi network and storage connected thereto as part of a reservation. A mobile agent may communicate with a router agent for the WiFi network to perform any of the functions described above in FIGS. 6-9. That is, the WiFi network may download and store content offline and make the content accessible to the wireless device when the wireless device connects to the WiFi network. The use of business networks in this manner is not limited to hotels. Rather, various businesses (e.g., restaurants, gyms, convention centers) may provide this type of service without departing from the current scope.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

We claim:

1. A method for utilizing a local area network to manage video playback on a wireless device associated with the local area network, the method comprising
receiving a message from the wireless device that includes information about content associated with the wireless device and a request for the local area network to download the content;
downloading the content from a content provider offline via the local area network;
storing the content on a storage device connected to the local area network;
determining when the wireless device is connected to the local area network; and
providing the wireless device access to the stored content.

2. The method of claim 1, wherein the receiving the message includes receiving the message that includes information about a currently-playing content that is currently being played on the wireless device including current playback position of the content.

3. The method of claim 2, wherein
the currently-playing content is currently being played via a mobile network;
the receiving the message includes receiving the message that includes location of the wireless device;
further comprising determining an approximate playback position of the currently-playing content when the wireless device connects to the local area network; and
the downloading includes downloading the currently-playing content from the approximate playback position.

4. The method of claim 3, wherein the providing the wireless device access to the stored content includes switching playback of the currently-playing content from active downloading to the currently-playing content stored in the storage device at an appropriate point.

5. The method of claim 2, wherein:
the currently-playing content is currently being played via a first wireless frequency band of the local area network and bandwidth associated with the first wireless frequency band is limited and playback of content is below desired quality;
the step of receiving the message includes receiving the message that includes a request for downloading the currently-playing content via an alternative to the first wireless frequency band;
the method further comprises finding available bandwidth on the local area network as the alternative to the first wireless frequency band; and
the step of downloading includes downloading the content via the available bandwidth.

6. The method of claim 5, wherein
the step of finding the available bandwidth includes finding the available bandwidth on a wired connection to the local area network or on a wireless connection operating at a different frequency band; and
the step of downloading the content via the available bandwidth includes downloading the content via the wired connection to the local area network or via the wireless connection operating at the different frequency band.

7. The method of claim 1, wherein the step of receiving the message includes receiving the message that includes information about content that is on a wish list for the wireless device.

8. The method of claim 7, wherein the step of providing the wireless device access to the stored content includes enabling playing of the content on the wish list from the content stored in the storage device.

9. The method of claim 7, wherein the step of providing the wireless device access to the stored content includes enabling copying of the content on the wish list from the content stored in the storage device to the wireless device.

10. A device to provide, to a wireless device, an access point for a local area network and to manage video playback on the wireless device, the device comprising:
a wireless interface to communicate with one or more wireless devices;
a processor communicatively coupled to a memory for storing network configuration information, wherein the network configuration information includes network topology; and
a computer-readable storage medium to store instructions that when executed by the processor cause the processor to:
receive a message from the wireless device that includes information about content associated with the wireless device and a request for the local area network to download the content;
download the content from a content provider offline via the local area network;
store the content on a storage device connected to the local area network;
determine when the wireless device is connected to the local area network; and
provide the wireless device access to the stored content.

11. The device of claim 10, wherein when the instructions are executed they further cause the processor to:
receive a message that includes current playback position of a currently-playing content that is currently being played on the wireless device and current location of the wireless device;
determine an approximate playback position of the currently-playing content when the wireless device connects to the local area network, and
download the currently-playing content from the approximate playback position.

12. The device of claim 11, wherein when the instructions are executed they further cause the processor to instruct the wireless device to switch playback of the currently-playing content from active downloading to the currently-playing content stored in the storage device at an appropriate point.

13. The device of claim 10, wherein when the instructions are executed they further cause the processor to
receive a request for downloading currently-playing content via an alternative to current frequency band associated with the wireless device that has limited bandwidth that causes playback of content to be below desired quality;
find available bandwidth on the local area network as the alternative to the current frequency band, wherein the available bandwidth may be on a wired connection to the local area network or on a wireless connection operating at a different frequency band;
download the currently-playing content via the available bandwidth; and
instruct the wireless device to switch playback of the currently-playing content from active downloading to the currently-playing content stored in the storage device at an appropriate point.

14. The device of claim 10, wherein when the instructions are executed they further cause the processor to
receive a message that identifies content that is on a wish list for the wireless device; and
enable the wireless device to play the content on the wish list from the content stored in the storage device.

15. The device of claim 10, wherein when the instructions are executed they further cause the processor to
receive a message that identifies content that is on a wish list for the wireless device; and
enable the wireless device to copy the content on the wish list from the content stored in the storage device to the wireless device.

16. A system to manage video playback on a wireless device associated with a local area network, the system comprising:
a mobile agent configured to:
prepare a message including information about content associated with the wireless device, location of the wireless device and a request to download the content; and
send the message to the local area network; and
a router agent configured to:
receive the message from the wireless device;
download the content from a content provider offline;
store the content on a storage device connected to the local area network;
determine when the wireless device is connected to the local area network; and
provide the wireless device access to the stored content.

17. The system of claim 16, wherein
the mobile agent is further configured to include current playback position of a currently-playing content that is currently being played on the wireless device in the message; and
the router agent is further configured to:
determine an approximate playback position of the currently-playing content when the wireless device connects to the local area network;
download the currently-playing content from the approximate playback position; and
instruct the wireless device to switch playback of the currently-playing content from active downloading to the currently-playing content stored in the storage device at an appropriate point.

18. The system of claim 16, wherein
the mobile agent is further configured to include current frequency band utilized for playback and an indication the current frequency band has limited bandwidth that causes playback of content to be below desired quality in the message; and
the router agent is further configured to:
find available bandwidth on the local area network as an alternative to the current frequency band, wherein the available bandwidth may be on a wired connection to the local area network or on a wireless connection operating at a different frequency band;
download a currently-playing content via the available bandwidth; and
instruct the wireless device to switch playback of the currently-playing content from active downloading to the currently-playing content stored in the storage device at an appropriate point.

19. The system of claim 16, wherein
the mobile agent is further configured to include content on a wish list in the message; and
the router agent is further configured to enable the wireless device to play the content on the wish list from the content stored in the storage device.

20. The system of claim 16, wherein
the mobile agent is further configured to include content on a wish list in the message; and
the router agent is further configured to enable the wireless device to copy the content on the wish list from the content stored in the storage device to the wireless device.
